(19) United States
(12) Patent Application Publication
(10) Pub. No.: US 2013/0161581 A1
(43) Pub. Date: Jun. 27, 2013

(54) FLANGE SEPARATION APPARATUS

(71) Applicant: Yu-Lin CHEN, Taichung City (TW)

(72) Inventor: Yu-Lin CHEN, Taichung City (TW)

(21) Appl. No.: 13/332,979

(22) Filed: Dec. 21, 2011

(51) Int. Cl. B66F 3/24

(52) U.S. Cl. 254/93 R

(57) ABSTRACT

A flange separation apparatus includes a hydraulic cylinder and a movable member coupled with the hydraulic cylinder. The hydraulic cylinder includes an open end and a plurality of first spreading portions extended outwards from the open end. The movable member includes a movement portion and a plurality of second spreading portions connecting to the movement portion. The first and second spreading portions are perpendicular to the axis of the hydraulic cylinder and formed respectively varying first thickness and varying second thickness. As the hydraulic cylinder and movable member are parallel with the axis of flanges, operation space can be reduced. Moreover, through the first and second spreading portions, the flanges spaced from each other at different distances can be separated.

### FIELD OF THE INVENTION

The present invention relates to a separation apparatus for equipment and particularly to a flange separation apparatus.

### BACKGROUND OF THE INVENTION

Disassembly of flanges generally is done by striking a pinch bar located between two flanges to perform separation of the two flanges. Such an approach is prone to damage the flanges and tedious and takes a lot of time and efforts. To resolve this problem, U.S. Pat. No. 5,678,293 entitled “Tool for spreading opposed members apart” discloses a separation tool formed in an F shape. It adopts a hydraulic means to drive two spreader members at one end of the separation tool to separate two flanges. But the spreader members have a limited spreading interval, and cannot providing continuous spreading once the limited spreading interval is reached.

To remedy this problem, another flange separator as shown in FIG. 1 is developed. It has a hydraulic cylinder 1, two spreaders 2 coupled with the hydraulic cylinder 1 and a conical member 3 located between the two spreaders 2 and connected to the hydraulic cylinder 1. Each spreader 2 has a stepped contact portion 4 and a sloped surface abutting the conical member 3. The conical member 3 can be moved axially via the aid of the hydraulic cylinder 1.

Also referring to FIGS. 2 and 3, when in use, first, the spreaders 2 are inserted between two flanges 5 with the contact portion 4 in contact with the two flanges 5; then the conical member 3 is moved axially towards the flanges 5 to drive the spreaders 2 to expand to separate the two flanges 5. As the conical member 3 will reach the axis of the flanges 5 after advancing a certain distance, it must be drawn back to allow the contact portion 4 to move towards the axis as shown in FIG. 3 to continue the separation of the flanges 5; then the fourth step of the contact portion 4 is in contact with and butted by the two flanges 5, and the process of moving the conical member 3 towards the flanges 5 is repeated again to continuously separate the two flanges 5. Such a separation process is tedious and time-consuming. Moreover, the aforesaid flange separator is moved vertically towards the axis of the flanges 5 during operation. As the hydraulic cylinder 2 and conical member 3 are installed coaxially, total length cannot be reduced, thus a greater surrounding area must be provided around the flanges 5 to accommodate the flange separator, and otherwise the flange separator cannot be used to perform separation as desired.

### SUMMARY OF THE INVENTION

The primary object of the present invention is to solve the problem of the conventional flange separation process that is tedious and time-consuming.

Another object of the invention is to solve the problem of the conventional flange separators that are hard to insert between two flanges due to narrower operation space.

To achieve the foregoing objects, the present invention provides a flange separation apparatus that includes a hydraulic cylinder and a movable member coupled with the hydraulic cylinder. The hydraulic cylinder includes an open end, an oil piping system end relative to the open end, a housing chamber leading to the open end and a plurality of first spreading portions extended outwards from the open end. The first spreading portions are perpendicular to the axis of the hydraulic cylinder and formed at varying first thickness. The movable member includes a movement portion held in the housing chamber and a plurality of second spreading portions corresponding to the first spreading portions and connecting to the movement portion. The movement portion is movable along the axis of the hydraulic cylinder. The second spreading portions are perpendicular to the axis of the hydraulic cylinder and formed at varying second thickness. Through the first and second spreading portions perpendicular to the axis of the hydraulic cylinder and positioned between two flanges, the axis of the hydraulic cylinder is parallel with the axis of the two flanges, and the movable member can be moved along the axis of the two flanges, thereby to disassemble and separate the flanges within a narrower operation space. Moreover, with the first and second spreading portions formed in varying first and second thicknesses, they can be used on the flanges spaced from each other at different distances.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic side view of a conventional technique.

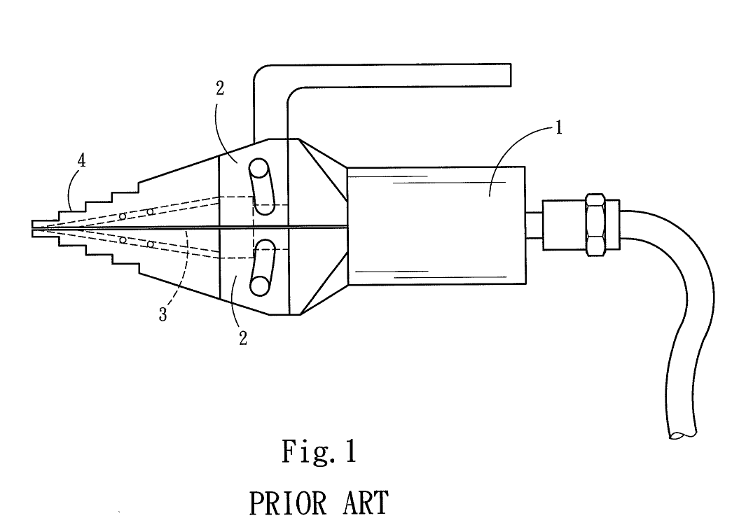

FIG. 2 is a schematic view of a conventional technique in a use condition.

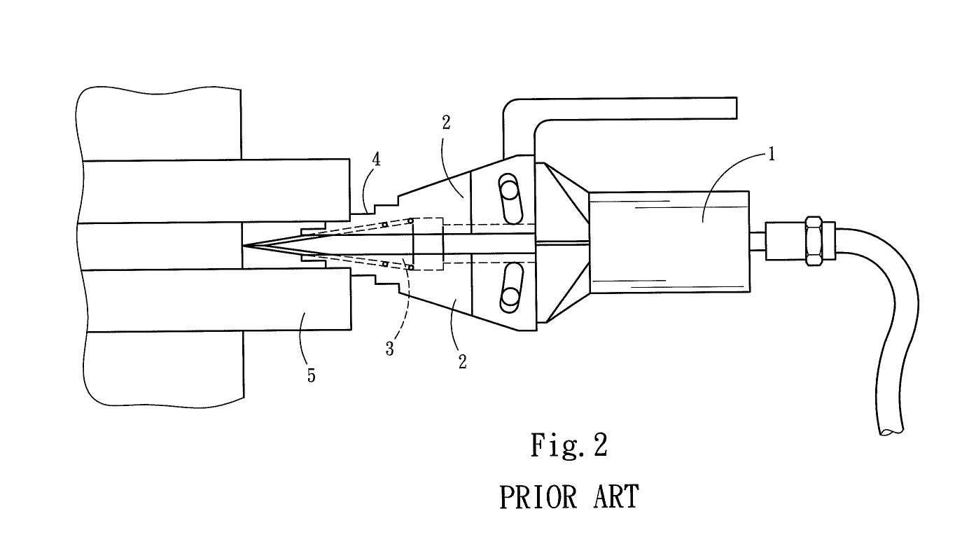

FIG. 3 is a schematic view of a conventional technique in another use condition.

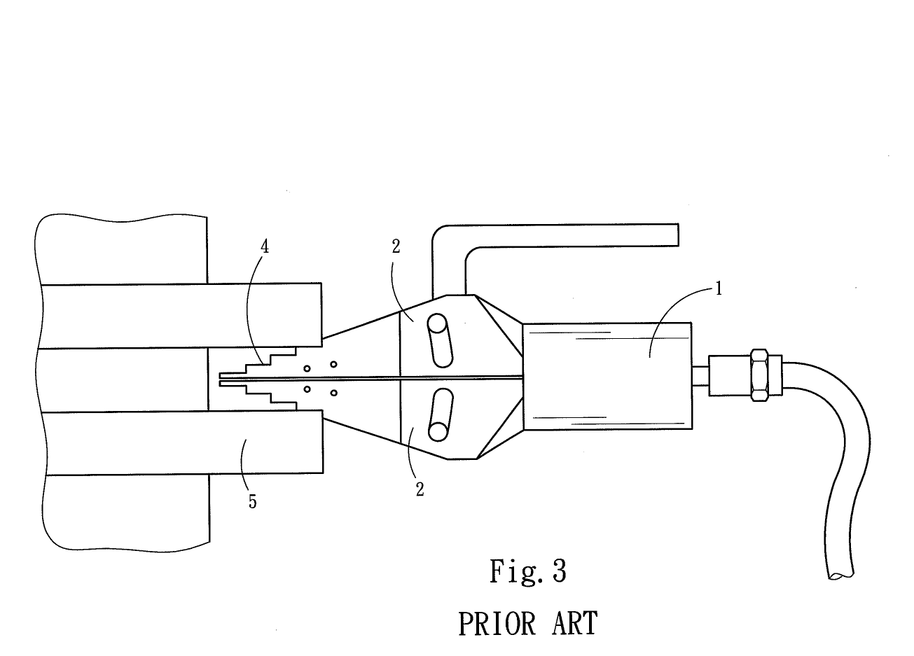

FIG. 4 is a perspective view of the invention.

FIG. 5 is a perspective view of the invention in a use condition by swiveling.

FIG. 6 is a fragmentary section view of the invention.

FIG. 7 is a side view of a first embodiment of the invention in a use condition.

FIG. 8 is a side view of a second embodiment of the invention in a use condition.

FIG. 9 is a side view of a third embodiment of the invention in a use condition.

### DETAILED DESCRIPTION OF THE PREFERRED EMBODIMENTS

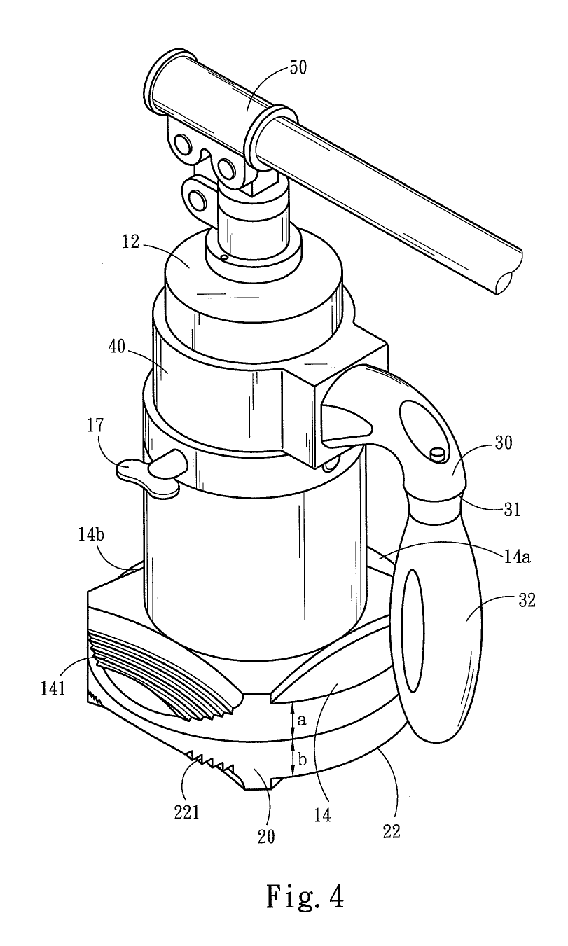

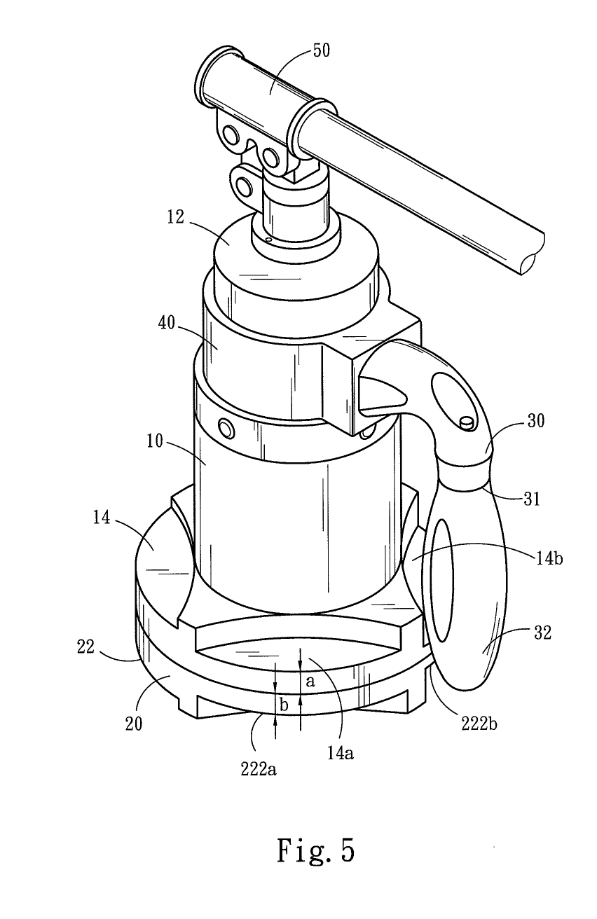

Please refer to FIGS. 4, 5 and 6, the present invention aims to provide a flange separation apparatus. It includes a hydraulic cylinder 10 and a movable member 20 coupled with the hydraulic cylinder 10. The hydraulic cylinder 10 includes an open end 11, an oil piping system end 12 relative to the open end 11, a housing chamber 13 leading to the open end 11 and a plurality of first spreading portions 14, 14a and 14b extended outwards from the open end 11. The first spreading portions 14, 14a and 14b are perpendicular to the axis of the hydraulic cylinder 10 and formed at varying first thickness. The movable member 20 includes a movement portion 21 held in the housing chamber 13 and a plurality of second spreading portions 22, 22a and 22b corresponding to the first spreading portions 14, 14a and 14b and connecting to the movement portion 21. The movement portion 21 is movable along the axis of the hydraulic cylinder 10. The second spreading portions 22, 22a and 22b are perpendicular to the axis of the hydraulic cylinder 10 and formed at varying second thickness b. The hydraulic cylinder 10 further has a first stepped positioning portion 141 extended outwards from the open end 11. The movable member 20 has a second stepped positioning portion 221 corresponding to the first stepped positioning portion 141. The first stepped positioning portion 141 is juxtaposed with the first spreading portions 14, 14a and 14b. The second stepped positioning portion 221 is also juxtaposed with the second spreading portions 22, 22a and 22b.

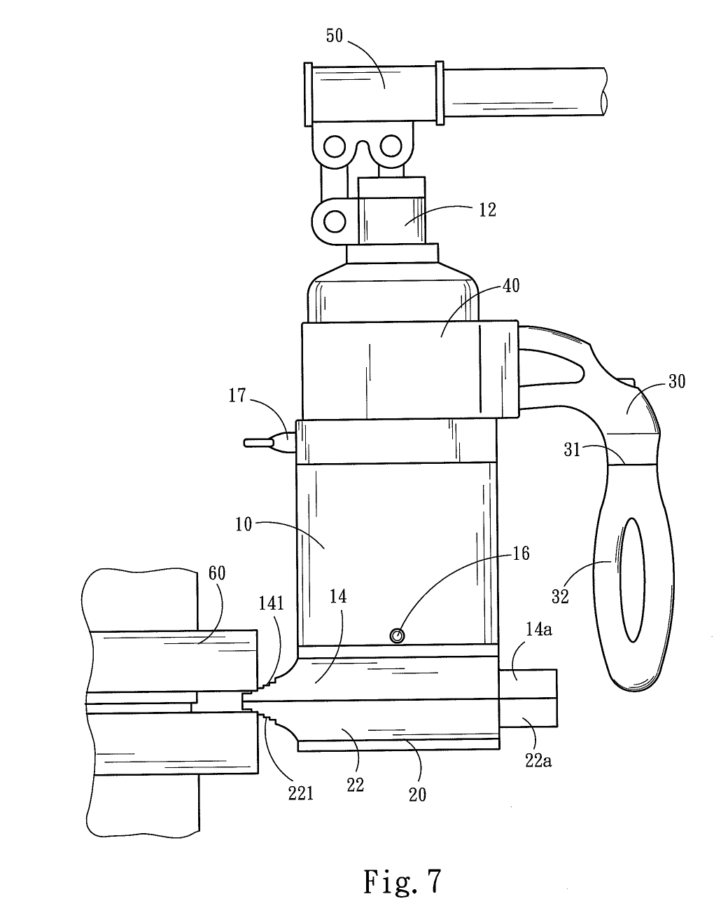

To improve usability and make operation possible in a narrower area, the invention also provides a handgrip 30 connecting to the hydraulic cylinder 10. The handgrip 30 includes an assembling end 31 and an illumination device 32 coupled with the assembling end 31. The illumination device 32 can be removed for use. In addition, in an embodiment, the hydraulic cylinder 10 further includes a coupling ring 40 on the outer surface thereof. The coupling ring 40 has a sliding portion 41, and the hydraulic cylinder 10 has an indented track 18 to receive the sliding portion 41 so that the handgrip 30 and the coupling ring 40 can be coupled and rotated about the surface of the hydraulic cylinder 10. The purpose of such swivel will be discussed later. The illumination device 32 can be removed from the handgrip 30 to aid illumination during separation process of flanges 60 (referring to FIG. 7).

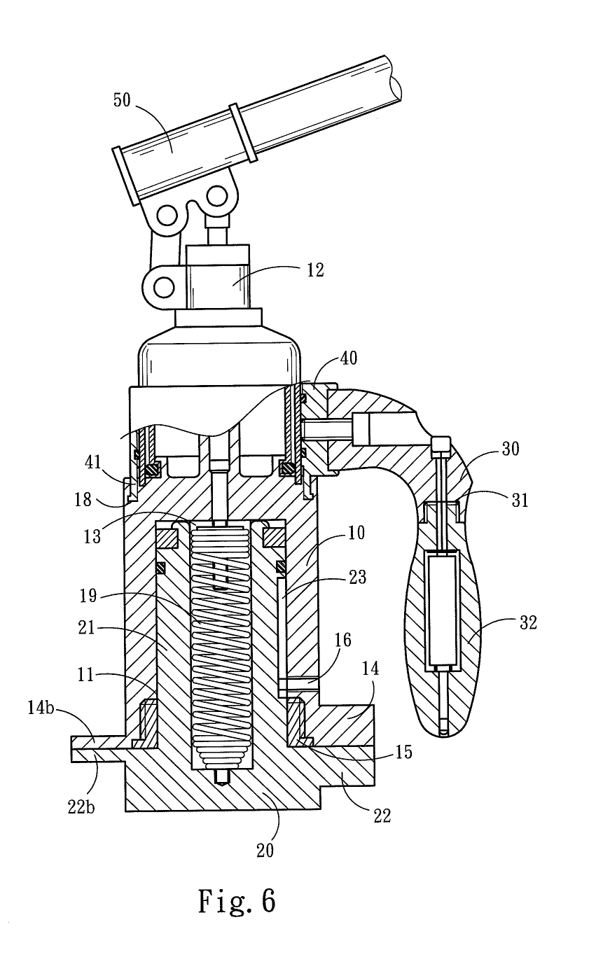

Also referring to FIG. 6, the oil piping system end 12 is pressurized via a manual operation bar 50 so that the movable member 20 is moved along the axis of the hydraulic cylinder 10 from the oil piping system end 12, and the second spreading portions 22, 22a and 22b are moved away from the first spreading portions 14, 14a and 14b. The movement portion 21 has an elongate groove 23 on an outer wall thereof parallel to the axis of the hydraulic cylinder 10, and the housing chamber 13 holds a fastening member 16 perpendicular to and inserting in the elongate groove 23 so that the movable member 20 can only be moved on the elongate groove 23 from the oil piping system end 12 until reaching the fastening member 16 to be stopped, thereby is confined the movement of the movable member 2 without separating from the hydraulic cylinder 10. The hydraulic cylinder 10 further has a pressure release unit 17 (referring to FIG. 4) and an elastic returning member 19. The pressure release unit 17 controls oil in the hydraulic cylinder 10 to flow back to the oil piping system end 12 to release the pressure. The elastic returning member 19 is held in the hydraulic cylinder 10 and coupled with the movable member 20 to draw the movable member 20 back after the pressure has been released.

The hydraulic cylinder 10 further includes a wear-resistant ring 15 located between the housing chamber 13 and movable member 20 to prevent the movable member 20 from wearing the open end 11 of the hydraulic cylinder 10 while the movable member 20 is moved reciprocally in the hydraulic cylinder 10, thereby is improved the lifespan thereof.

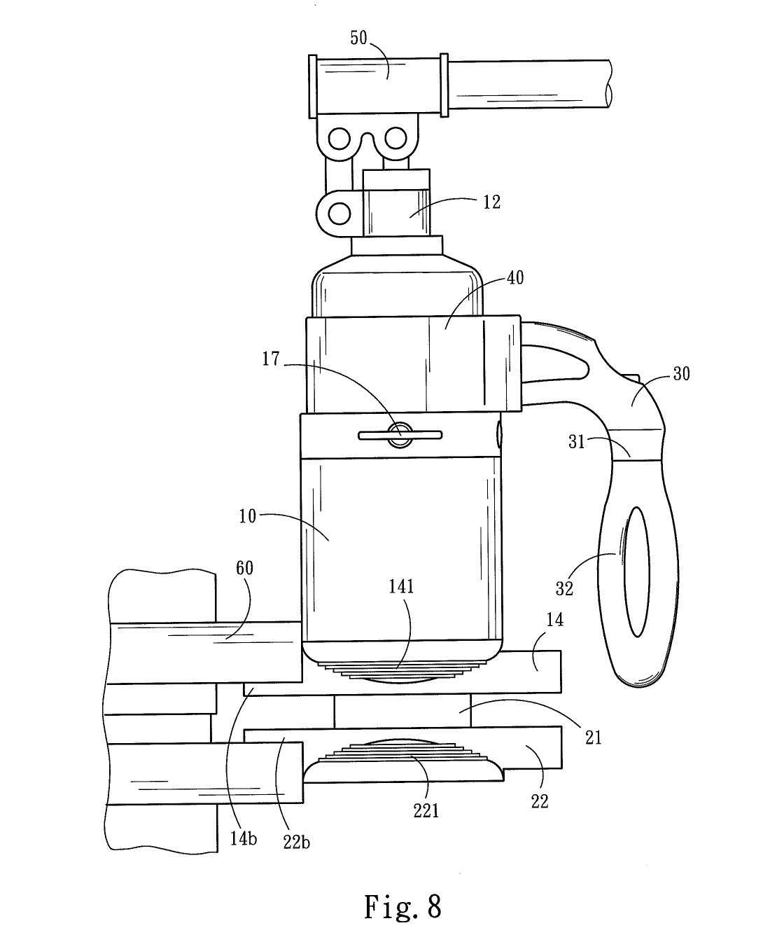

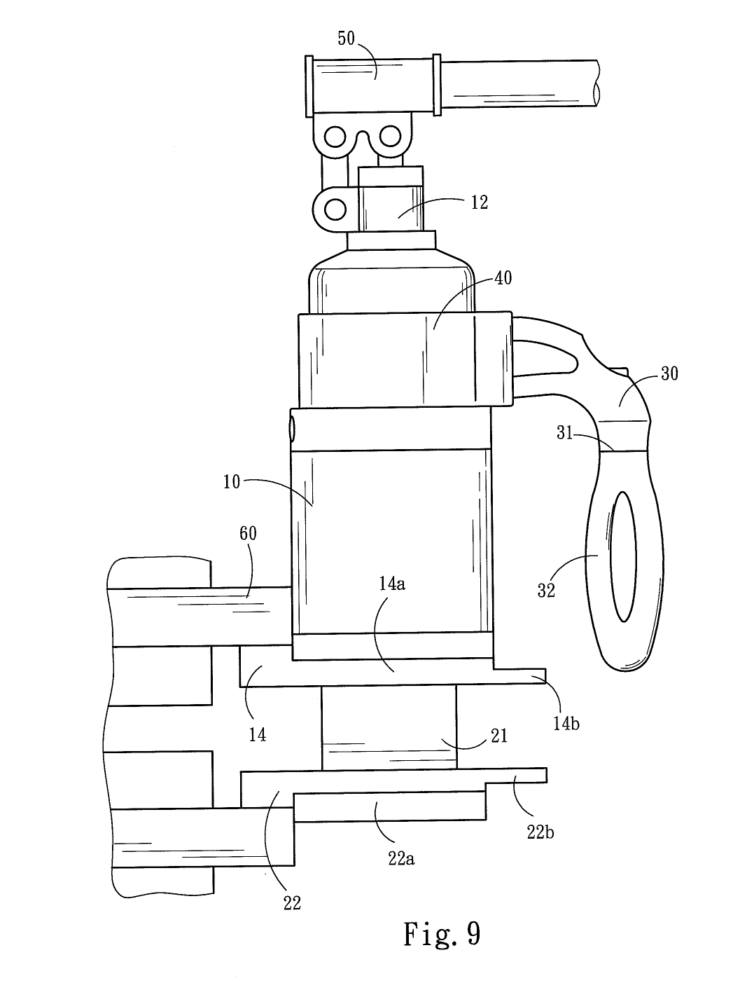

Referring to FIG. 7, during separation of the flanges 60, first, the first stepped positioning portion 141 and second stepped positioning portion 221 are inserted between the two flanges 60; then a pressure is applied via the manual operation bar 50 to the oil piping system end 12 to move the hydraulic cylinder 10 away from the movable member 20 to separate the two flanges 60. When the hydraulic cylinder 10 and movable member 20 are moved axially and relatively to the limit, the pressure is released first, and the first stepped positioning portion 141 and second stepped positioning portion 221 are moved towards the axis of the two flanges 60 so that the steps at the higher elevation are in contact with the two flanges 60 and positioned, and then the pressure is continuously applied to separate the flanges 60 apart. Refer to FIG. 8 for another approach. The hydraulic cylinder 10 and movable member 20 are rotated simultaneously to allow the first spreading portion 14b and second spreading portion 22b to move to the two flanges 60 to perform pressure applying and separation process. As the first spreading portion 14b and second spreading portion 22b form a greater contact area with the flanges 60, a steadier butting and spreading movement can be attained. Also referring to FIG. 9, the separation process can also be performed through another first spreading portion 14 and second spreading portion 22 of a maximum thickness. They have a greater thickness initially than other spreading portions, thus can separate the two flanges 60 at a greater distance.

Compared with the conventional techniques, the present provides features as follow:

1. With the first spreading portions 14, 14a and 14b and second spreading portions 22, 22a and 22b perpendicular to the axis of the hydraulic cylinder 10, the axis of the hydraulic cylinder 10 is parallel with the axis of the two flanges 60, thus the apparatus of the invention can be operated in a narrower space to disassemble and separate the flanges 60.

2. The first spreading portions 14, 14a and 14b and second spreading portions 22, 22a and 22b can be swiveled to mate different separation distances, thus are adoptable to the flanges 60 spaced from each other at varying distances. The first stepped positioning portion 141 and second stepped positioning portion 221 also can provide multi-stage spreading.

3. With the handgrip 30 coupled with the illumination device 32, the illumination device 32 can be removed to facilitate separation of the flanges 60 without carrying extra lighting equipment, thus is avoided the difficulty in separating the flanges 60 without the lighting equipment.

All this shows that the present invention provides significant improvements over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A flange separation apparatus, comprising:
a hydraulic cylinder including an open end, an oil piping system end relative to the open end, a housing chamber leading to the open end and a plurality of first spreading portions extended outwards from the open end and perpendicular to an axis of the hydraulic cylinder, the plurality of first spreading portions being formed at varying first thickness; and
a movable member which is coupled with the hydraulic cylinder and includes a movement portion held in the housing chamber and a plurality of second spreading portions connecting to the movement portion and corresponding to the first spreading portions, the movement portion being movable along the axis of the hydraulic cylinder, the plurality of second spreading portions being perpendicular to the axis of the hydraulic cylinder and formed at varying second thickness.

2. The flange separation apparatus of claim 1, wherein the hydraulic cylinder further includes a first stepped positioning portion extended outwards from the open end, the movable member including a second stepped positioning portion corresponding to the first stepped positioning portion, the first stepped positioning portion being juxtaposed with the first spreading portions, the second stepped positioning portion being juxtaposed with the second spreading portions.

3. The flange separation apparatus of claim 1 further including a handgrip connecting to the hydraulic cylinder, the handgrip including an assembling end and an illumination device coupled with the assembling end.

4. The flange separation apparatus of claim 1 further including a coupling ring on an outer surface of the hydraulic cylinder and a handgrip connecting to the coupling ring, the handgrip including an assembling end and an illumination device coupled with the assembling end.

5. The flange separation apparatus of claim 4, wherein the coupling ring includes a sliding portion, the hydraulic cylinder including an indented track to receive the sliding portion.

6. The flange separation apparatus of claim 1, wherein the hydraulic cylinder further includes a wear-resistant ring located between the housing chamber and the movable member.

7. The flange separation apparatus of claim 1, wherein the movement portion includes an elongate groove on an outer wall thereof parallel to the axis of the hydraulic cylinder, the housing chamber holding a fastening member perpendicular to and inserting in the elongate groove.

8. The flange separation apparatus of claim 1 further including a manual operation bar connecting to the oil piping system end.
